(19) United States
(12) Patent Application Publication
(10) Pub. No.: US 2017/0325301 A1
(43) Pub. Date: Nov. 9, 2017

(54) Methods And Systems Of Proactive Monitoring And Metering Of Lighting Devices

(71) Applicant: Lightel Technologies, Inc., Renton, WA (US)

(72) Inventors: Chia-Yiu Maa, Bellevue, WA (US); Chunte Yu, Bellevue, WA (US)

(21) Appl. No.: 15/658,317

(22) Filed: Jul. 24, 2017

Related U.S. Application Data
(63) Continuation-in-part of application No. 14/527,691, filed on Oct. 29, 2014, now Pat. No. 9,746,529.
(60) Provisional application No. 61/899,222, filed on Nov. 3, 2013.

(51) Int. Cl. H05B 33/08; G06Q 50/06; G06Q 20/14; G01J 1/42; G01D 4/02

(52) U.S. Cl. CPC H05B 33/089; H05B 33/0887; G06Q 50/06; G01D 4/02; G06Q 20/145; G01J 1/42; G01J 2001/4252

(57) ABSTRACT

Various embodiments of methods and systems of proactive monitoring and metering of lighting devices are described herein. A light monitoring and metering system may include a specification database that stores the technical specification of the lighting device, a usage database that records the usage data of the lighting device, a data acquisition subsystem that obtains the identity of the lighting device in use, and a data processing subsystem that meters the usage or calculates the lumen output of the lighting device or the remaining lifetime of the driver of the light device.

### CROSS REFERENCE TO RELATED PATENT APPLICATION

This is a continuation-in-part patent application to U.S. Non-provisional Patent Application No. 14/527,691, filed on Oct. 29, 2014, which claims the priority benefit of U.S. Provisional Patent Application No. 61/899,222, filed on Nov. 3, 2013. The contents of aforementioned applications are incorporated by reference in their entirety.

### TECHNICAL FIELD

The present disclosure relates to the monitoring of lighting devices, including but not limited to LED lighting devices.

### BACKGROUND

In the parent application, U.S. patent application Ser. No. 14/527,691, methods and systems of proactive monitoring of LED lights were described. The general principles of that disclosure can be readily extended to non-LED lighting devices. Moreover, when monitoring a lighting device, metering can also be performed at the same time by the same data processing subsystem without altering the construction of the monitoring system. While monitoring and metering both can be done simultaneously by the same data processing subsystem, they serve different purposes. Monitoring is more on the performance and the heath of the lighting devices in use and subsequently their maintenance. In contrast, metering focuses more on the actual usage of the lighting devices and affects directly the usage-base charge and billing, similar to the electricity metering and billing of a household.

The systems of proactive monitoring of LED lights described in U.S. patent application Ser. No. 14/527,691 may imply implicitly that they are external to the LED lights being monitored. With the availability of the micro-electronics technology, this restriction can thus be lifted. A system of proactive monitoring of lighting devices may be imbedded partially or wholly inside of the lighting device in use.

The generalization of U.S. patent application Ser. No. 14/527,691, among various aspects mentioned above, will be described in the present disclosure. When implemented, these expanded functionalities will increase the utility of the parent application and result in operation benefits to the user of the systems and methods of the monitoring and metering of lighting devices.

### SUMMARY

The present disclosure is a system for monitoring and metering of lighting devices. It comprises of at least one usage database, at least one data acquisition subsystem, and at least one data processing subsystem.

The usage database of the present disclosure contains or otherwise stores the usage data of the lighting device and its driver registered with the system, such as operation start date, daily operation hours, total energy consumption, the light dimming level information, etc.

The data acquisition subsystem of the present disclosure captures or otherwise obtains the identity of the lighting device in use and the identity data such as the model number of the lighting device or its driver and its unique ID in the system.

The data processing subsystem of the present disclosure meters the usage data of the light device and saves the data in the usage database. For example, by using the start date and the daily operation hours, the data processing subsystem can determines the total operation hours of a lighting device and its driver. Multiplying the total hours with the wattage consuming the lighting device or its driver, the energy consumption in KWH (Kilo-watt-hour) can then be calculated and subsequently used to determine the electrical usage rate for this lighting device or its driver individually.

Some embodiment of the present disclosure uses a specification database for storing the technical specification of the lighting device and its driver, such as the lumen maintenance decay data of the lighting device and the lifetime data of its driver. The data processing subsystem of the present disclosure statistically calculate the lumen output of a lighting device or the remaining lifetime of its driver, by using its usage data in the usage database, its identity captured by the data acquisition subsystem, and the lighting device and driver specification data in the specification database. For example, the data processing subsystem can compare with the lumen maintenance decay data of the lighting device in the specification database according to the total operation hours of the lighting device for interpolating the current lumen maintenance level of the lighting device. Similarly, by comparing the total operation hours of a light device driver and the statistical lifetime data of this driver type in the specification database, the data processing subsystem can determine the remaining lifetime of the driver. The data processing subsystem may also provide a user interface for a user to enter the data into the subsystem.

Before a new lighting device or its driver can be monitored by the system of the present disclosure, its specification data needs to be entered and stored the specification database first. Then upon the installation and first operation of this lighting device or it driver, the data acquisition subsystem is used to capture its identity and then passes it to the data processing system. The data processing subsystem will then record the additional information such as the start date, daily operation hour, etc., and save them along with the to the lamp/driver identity to the usage database. Upon subsequent maintenance check-ups of the lighting device or its driver in use, the data acquisition subsystem again identifies its identity and passed it to the data processing subsystem. The data processing subsystem retrieves the start date and daily operation information from the usage database, captures the current date, calculates the total operation hours of the lighting device or its driver, and then compare it to the data in the specification database to drive statistically the current lumen output level of the lighting device or the remaining lifetime of its driver.

In one aspect of the present disclosure, the usage database of the present disclosure records, in addition to the start date of a lighting device or its driver, the daily usage hours, e.g., 8 am to 6 pm, or usage pattern, e.g., Monday to Friday. This enables the data processing subsystem to calculate the actual total usage hour of a lighting device or its driver.

When a lighting device or its driver operates at a reduced power level, for example, dimmed at 50% of its full capacity, the lighting device or driver's effective usage is actually half of that operating in full capacity. If a lighting device is on in 24-hour per day fashion, yet 50% of the time at 100% lumen output and 50% of the time at 30% lumen output, then its effective daily usage hour is 12 hours*100%+12 hours*30%=12+3.6=15.6 hours, not 24 hours. If the L70 maintenance hours (the total hours before the lumen output drop below 70% of its original level) of the light source of a lighting device is 50,000 hours when operating in 100% power level, operating at 15.6 effective-daily-hour extends the total L70 maintenance hours from 50,000 to 50,000*24/15.6=76,900 hours.

Thus, by factoring in the dimming level and duration, the extended overall operation hours of the lighting device increases by more than 50%. This could lead to 50% material and labor savings on lighting device and driver maintenance costs. Another aspect of the present disclosure is that the data processing subsystem uses the light dimming level and duration to calculate the effective daily usage hours of a light device or its driver, or its extended overall operation hours so as to reduce the lighting device and driver maintenance costs.

In another aspect of the present disclosure, the subsystems may be physically external to the lighting device to be monitored, and it may run on one or more personal computer, tablet computer, smart phone, or any other computing device or equipment with data entry, processing, and storage capabilities. When running on more than one physical computing devices, the components of the system are connected via wired or wireless or the combination thereof communication mechanism through point-to-point, local area network, wide area network, or internet. There is no restriction to have all components of the system running one physical device or physical location. For a large scale deployment, the computing device used by a field maintenance crew may contain only a partial specification database as related to the lighting devices and drivers used in his/her territory, the usage data of these lighting devices/drivers, the data acquisition subsystem, and the data processing system. In such scenario, the local data processing subsystem may upload the local usage database to a centralized usage database at a data center, and the local data processing may also download the partial specification database update from a centralized specification database in the data center to the local specification database to the computing device used by the maintenance crew on an as-needed basis.

In another aspect of the present disclosure, the subsystems may be embedded partially or wholly in the lighting device that is monitored by the system. In this scenario, the subsytems may monitor only the lighting device that they reside at. When this is the case, the data acquisition subsystem and the data process subsystem may be combined into one subsystem. Moreover, the identity of the combined data acquisition/processing subsystem may be used in place of the identity the lighting device or its driver, thus simplifying the matching of the identity of the combined data acquisition/processing subsystem and the identity of the lighting device or its driver.

In another aspect of the present disclosure, the monitoring and metering system reports the usage data of the lighting device being monitored to an external billing system. This enables a new business model such that a lighting device can be charged by its actual usage or service, rather than by a one-time purchase cost. This will benefit the end users by amortizing the cost of a lighting fixture over the lifetime of the lighting device. It also benefit the user who uses less of the lighting device to pay less, and pay more as the usage need increased. This is just like the electricity or any utility, the user pays by the usage of the utility. It is also feasible to split the usage charge of a shared lighting device by different time segment and calculate it to the actual usage for each time segment. For example, for the lighting devices in a hotel room, the hotel may be able to charge a hotel guest accurately the lighting devices usage during the stay of the guest, rather than a fixed charge, thus encouraging hotel guest to be more energy-conscientious and preserving energy. With the present disclosure, the lighting device can now be used and billed as a utility according to the actual usage. The bill of the lighting fixture usage may include a certain fixed or surge charge, similar to the electricity bill. However, this doesn't affect the novelty of the present disclosure for enabling a new, usage-based operation and service of a lighting device.

In another aspect of the present disclosure, a usage allowance of a lighting device being may be configured by the monitoring and metering system. In the event the actual usage exceeds the usage allowance, the system will enforce the usage allowance by alerting the user, turning off the lighting device, a combination thereof, or other reasonable measures. The usage allowance may be in terms of time (e.g., hours), a monetary amount (e.g., in terms of dollars), energy consumption (e.g., KWH), or any other form of credit. An embodiment may lower the lighting level of the light device as the usage of the lighting device is approaching to the allowance limit, thus forcing the user to purchase additional credit/allowance or cut back on the usage of the light device. This functionality enables another new business model where a user can pre-purchase the usage credit for a lighting device, similar what a prepaid phone card could do to a phone, and operate the lighting device according the purchased credit or allowance. It is also foreseeable of using a prepaid/cash card for setting the usage allowance, and the data acquisition subsystem is equipped with a card reader to read the prepaid/cash card and deduct the credit on the card according to the actual usage of the lighting device.

The concept of metering and charging a lighting device by usage and enforcing the usage of the lighting device according a usage allowance is readily extendable to non-lighting electrical equipment. Thus some embodiment of the present disclosure comprises of a system identity, a usage database and a data processing subsystem. The data processing subsystem may be configured to access the power supply line to at least one electrical equipment. It may be further configured to meter the usage data of the at least one electrical equipment through its access of the power supply line to the electrical equipment, and may save the data in the usage database. Moreover, the data processing subsystem may report the equipment usage data and the identity of system to an external billing system in either or both of wired and wireless ways for the calculation of the usage charge of the at least one electrical equipment.

The metering and billing calculation of the present disclosure is not to be confused with the metering and billing on the electricity usage of the electrical equipment as done by the standard electric meter. The metering and billing of the present disclosure emphasizes on the metering and billing on the usage of the electrical equipment itself, not the electricity used by the electrical equipment. Borrowing the analogy from a rental car operation, billing on the electricity of the electrical equipment is similar to the billing on the gasoline usage of a rental car. In contrast, billing on the usage of the electrical equipment itself is similar to the billing on the mileage of the rental car. These two metering/billings are for completely different. The present disclosure enables the electrical equipment to be metered and billed on its mileage, so to speak. In the rental car scenario, the gasoline is paid to the gasoline company whereas the mileage used to the rental car company. With the present disclosure, the electricity may be paid to the utility company whereas the usage of the electrical equipment to the equipment rental company. So the present disclosure is not be confused with the existing electricity-only metering and billing. Rather, it is a usage meter that may include information such as the total number of hours (i.e. mileage) operated, in addition to the total number of KWH (i.e. electricity/gasoline) consumed. It is foreseeable to use one physical device for the metering and billing of both the electricity AND the electrical equipment. Nonetheless, the metering and billing on the usage of the electrical equipment(s) itself as enabled by the present disclosure is novel, practical, and highly useful.

In one aspect of the present disclosure the usage metering system may be embedded in one electrical equipment. In this case, the embedded system may meter only one electrical equipment, namely, the one it resides in.

Some embodiment of the present disclosure comprises of a system identity, a usage database and a data processing subsystem. The data processing subsystem may be configured to access the power supply line to the at least one electrical equipment. It may be further configured to accept a usage allowance of the at least one electrical equipment where the usage allowance is in the form of monetary amount, time duration, energy consumption measure, or any other form of usage credit. Moreover, the data processing subsystem may be configured to enforce the usage allowance through its access of the power supply line to the at least one electrical equipment by turning the electrical equipment(s) on, off, or partially on. Optionally, the usage allowance may be associated with the identity of the system.

In one aspect of the present disclosure the usage allowance enforcement system may be embedded in one electrical equipment. In this case, the embedded system may be configured to enforce the usage allowance on this one electrical equipment.

The claims and advantages will be more readily appreciated as the same becomes better understood by reference to the following detailed description and the accompanying drawings showing exemplary embodiments, in which like reference symbols designate like parts. For clarity, various parts of the embodiments in the drawings are not drawn to scale.

### BRIEF DESCRIPTION OF THE DRAWINGS

The accompanying drawings are included to aid further understanding of the present disclosure, and are incorporated in and constitute a part of the present disclosure. The drawings illustrate a select number of embodiments of the present disclosure and, together with the detailed description below, serve to explain the principles of the present disclosure. It is appreciable that the drawings are not necessarily in scale as some components may be shown to be out of proportion than the size in actual implementation in order to clearly illustrate the concept of the present disclosure.

FIG. 1 schematically depicts an embodiment of the present disclosure wherein the monitoring and metering system comprises of one specification database, one usage database, one data processing subsystem, and one data acquisition subsystem, and the subsystems are physically external to the lighting device in use.

FIG. 2 schematically depicts an embodiment of the present disclosure wherein the monitoring and metering system is embedded in the lighting device in use, and the data acquisition subsystem and the data processing subsystem are physically combined into a single subsystem.

FIG. 3 schematically depicts an embodiment of the present disclosure wherein the usage data is reported to an external billing system for calculating the usage charge of the lighting device in use. Moreover, the external system can set the usage allowance of the lighting device in use through the monitoring and metering system.

FIG. 4 is a flowchart of an example process in accordance with an embodiment of the present disclosure.

### DETAILED DESCRIPTION OF PREFERRED EMBODIMENTS

Various implementations of the present disclosure and related inventive concepts are described below. It should be acknowledged, however, that the present disclosure is not limited to any particular manner of implementation, and that the various embodiments discussed explicitly herein are primarily for purposes of illustration.

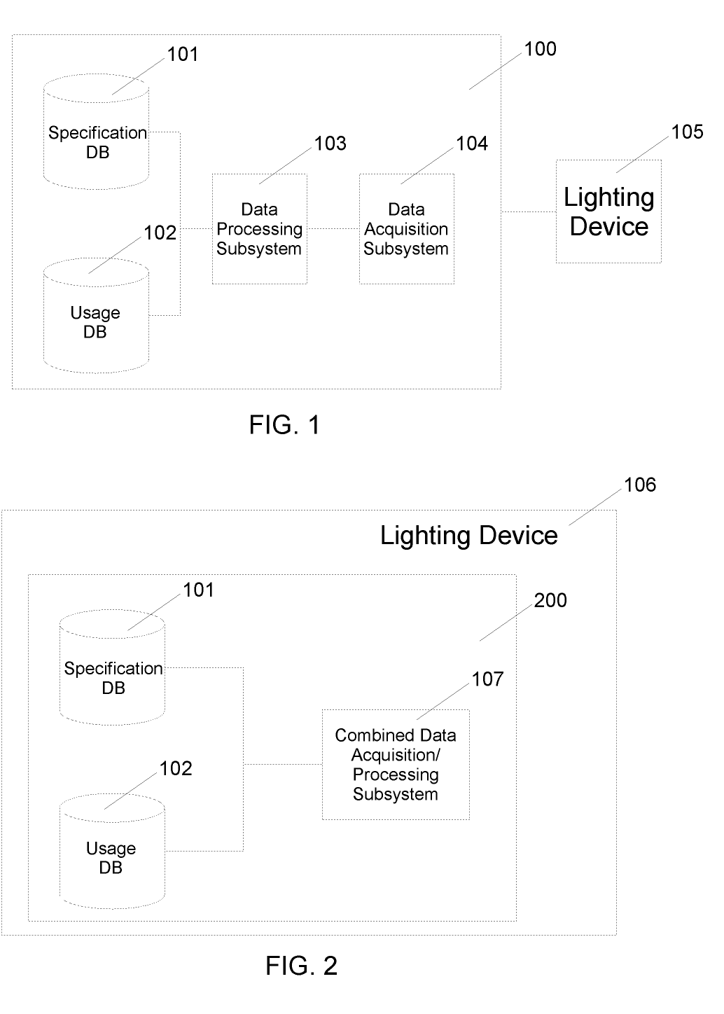

FIG. 1 illustrates one non-limiting example of a system according to one embodiment of the present disclosure. The monitoring and metering system 100 includes one specification database 101, one usage database 102, one data processing subsystem 103, and one data acquisition subsystem 104.

The specification database 101 contains the specification information of the light device and its driver to be monitored by the present disclosure. The information includes, but is not limited to, the model information of the light lighting device and the lumen maintenance decay data, and the model information of each driver and its lifetime data.

The usage database 102 includes, but is not limited to, the start time, the daily operation hour, the dimming information, and the effective daily usage hour of LED lamps and drivers. The usage database 102 may also contains the energy consumption data such KWH data.

In a simplified embodiment of the present disclosure where only the metering of the lighting device is needed, but not the detailed monitoring, the specification database 101 may be omitted.

The data processing subsystem 103 collects the usage data, stores the data in the usage database 102, computes the total operation hours and the effective daily usage hours of a lighting device and compares it with the corresponding lumen maintenance decay data in the specification database 101 to determine the current lumen output level of the lighting device. The data processing subsystem 103 also computes total operation hours of a lighting device driver and compares them with the corresponding driver lifetime data in the specification database 101 to determine the remaining lifetime of the driver.

Though not shown in the figure, the data processing subsystem 103 may have a user interface for a user to enter the data, such as the start date, current date, the daily operation hours, the dimming information, and the usage allowance into the subsystem.

The subsystems of the embodiment 100 may run on one or more personal computer, tablet computer, smart phone, or any other computing device or equipment with data entry, processing, and storage capabilities, and when running on more than one physical computing devices, the components of the system are connected via wired or wireless or the combination thereof communication mechanism through point-to-point, local area network, wide area network, or internet.

In FIG. 1, the embodiment of the present disclosure resides externally to the lighting device 105 being monitored. However, this is not necessarily the case. FIG. 2 illustrates another example embodiment of the present disclosure, wherein the monitoring and metering system 200 is embedded inside the lighting device 106 in use. Moreover, the data acquisition subsystem and the data processing subsystem are merged into one combined data acquisition/processing subsystem 107. In this case of embedding the monitoring and metering system in the lighting device in use, the system may only monitor one lighting device. Thus, there is a one-to-one relationship between the identity of the lighting device 106 and the identity of the combined data acquisition/processing subsystem 107. In this case the identity of the combined data acquisition/processing subsystem 107 can be used in place of the identity of the lighting device 106.

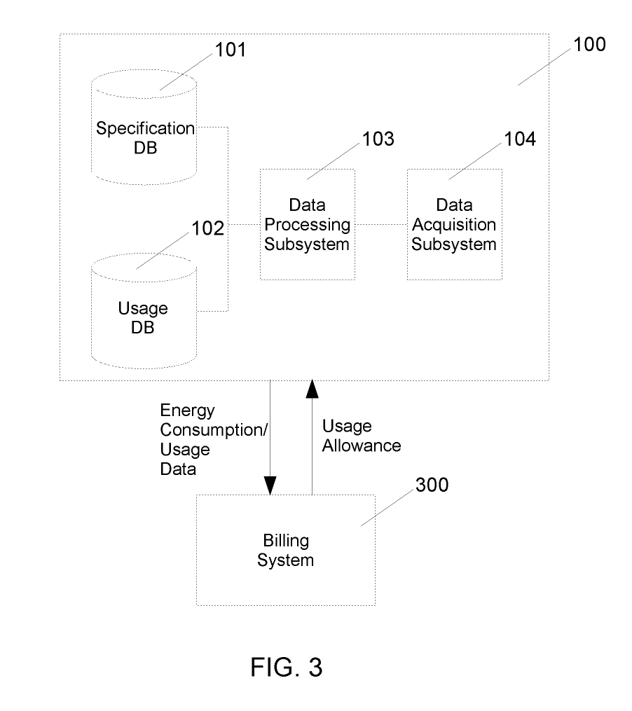

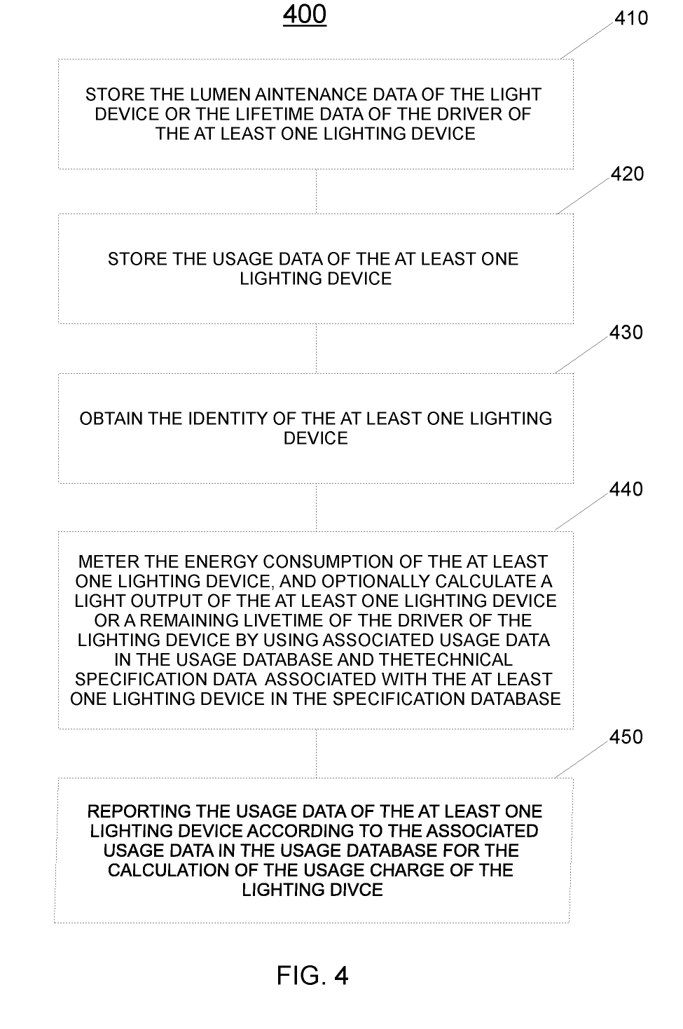

FIG. 3 illustrates another aspect of the present disclosure wherein the monitoring and metering system 100 reports the usage data of a lighting device in use to an external billing system 300. With the usage data, the external billing system 300 may calculate the charge of the lighting device based on the actual usage, similar to a household is charged on its electricity according to the actual usage of the electricity. Additionally, the external billing system 300 may set an allowance of a lighting device through the monitoring and metering system 100, and the system enforces the allowance by monitoring the usage of the light device in use. The usage allowance may be in terms of time (e.g., hours), a monetary amount, energy consumption (e.g., KWH), or any other form of credit. In the even that allowance is reached, the system 100 may turn off the lighting device, alert the user, or lower the lighting level. It is not required to set the usage allowance through the external billing system. The usage allowance may be configured directly by the monitoring and metering system through, for example, the user interface of the data acquisition subsystem or a cash card reader.

In at least some embodiments, example process 400 may store the technical specification of the lighting device and its driver in a specification database 410, store the usage data in a usage database 420, obtain the identity of the lighting device 430, meter the usage and the light output and the lifetime of the lighting device driver 440, and report the usage data 450.

When light output of the lighting device and the lifetime of the lighting device driver are not required, the process of storing technical specification in the specification database 410 may be omitted, and the process 440 may be reduced to only meter the usage of the lighting device.

Although the techniques have been described in language specific to certain applications, it is to be understood that the appended claims are not necessarily limited to the specific features or applications described herein. Rather, the specific features and examples are disclosed as non-limiting exemplary forms of implementing such techniques.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

For the purposes of this disclosure and the claims that follow, the terms “coupled” and “connected” may have been used to describe how various elements interface. Such described interfacing of various elements may be either direct or indirect.

What is claimed is:

1. A light monitoring and metering system, comprising:
a usage database capable of storing usage data of at least one lighting device;
a data acquisition subsystem capable of obtaining an identity of the at least one lighting device; and
a data processing subsystem capable of metering the usage data of the at least one lighting device and storing the usage data in the usage database.

2. The light monitoring and metering system of claim 1, further comprising:
a specification database capable of storing technical specification data of at least lumen maintenance data of the at least one lighting device or a lifetime of a driver of the at least one lighting device,
wherein the data processing subsystem is further configured to calculate a lumen output of the at least one lighting device or a remaining lifetime of the driver of the at least one lighting device by using the usage data in the usage database and the technical specification data associated with the at least one lighting device in the specification database.

3. The light monitoring and metering system of claim 2, wherein the usage database is further configured to record additional hours-per-day usage data, and wherein the data processing subsystem is further configured to calculate an actual total usage hour of the at least one lighting device based at least in part on the additional hours-per-day usage data.

4. The light monitoring and metering system of claim 3, wherein the usage database is further configured to record light dimming information, and wherein the data processing subsystem is further configured to calculate an effective daily usage time of the at least one lighting device based at least in part on the light dimming information.

5. The light monitoring and metering system of claim 1, wherein the at least one lighting device is physically external to the lighting monitoring and metering system.

6. The light monitoring and metering system of claim 1, wherein the data acquisition subsystem and the data processing subsystem are partially or wholly embedded in the at least one lighting device.

7. The light monitoring and metering system of claim 6, wherein the data acquisition subsystem and the data processing subsystem are physically combined into a single subsystem.

8. The light monitoring and metering system of claim 7, wherein an identity of the combined single subsystem is used as the identity of the at least one lighting device.

9. The light monitoring and metering system of claim 2, wherein at least some of the specification database, the usage database, the data acquisition subsystem, and the data processing subsystem communicate with each other through a point-to-point communication mechanism, a local area network, a wide area network, the Internet, or a combination thereof in either or both of wired and wireless ways.

10. The light monitoring and metering system of claim 1, wherein the usage data of the at least one lighting device stored in the usage database is reported by the data processing subsystem to an external billing system in either or both of wired and wireless ways to calculate a usage charge of the at least one lighting device.

11. The light monitoring and metering system of claim 1, wherein a usage allowance of the at least one lighting device, in terms of time, a monetary amount, energy consumption, or any other form of credit, is configured and enforced by the data processing subsystem.

12. A method of proactive monitoring and metering of lighting devices, comprising:
storing, in a usage database, usage data of at least one lighting device;
obtaining, by a data acquisition subsystem, an identity of the at least one lighting device; and
metering, by a data processing subsystem, the usage data of the at least one lighting device to save the usage data in the usage database.

13. The method of claim 12, further comprising:
storing, by a specification database, technical specification data of at least the lumen maintenance data of the at least one lighting device or a lifetime of a driver of the at least one lighting device; and
calculating, by the data processing subsystem, a lumen output of the at least one lighting device or a remaining lifetime of the driver of the at least one lighting device by using the usage data in the usage database and the technical specification data associated with the at least one lighting device in the specification database.

14. The method of claim 12, further comprising:
recording, by the usage database, additional hours-per-day usage data; and
calculating, by the data processing subsystem, an actual total usage hour of the at least one lighting device based at least in part on the additional hours-per-day usage data.

15. The method of claims 14, further comprising:
recording, by the usage database, light dimming information; and
calculating, by the data processing subsystem, an effective daily usage time of the at least one lighting device based at least in part on the light dimming information.

16. The method of claim 12, further comprising:
reporting, by the data processing subsystem, the usage data of the at least one lighting device stored in the usage database to an external billing system in either or both of wired and wireless ways to calculate a usage charge of the at least one lighting device.

17. The method of claim 12, further comprising:
configuring, by the data processing subsystem, a usage allowance of the at least one lighting device; and
enforcing, by the data processing subsystem, the usage allowance of the at least one lighting device in terms of time, a monetary amount, energy consumption, or any other form of credit.

18. A usage metering system, comprising:
an identity of the system;
a usage database; and
a data processing subsystem,
wherein:
the data processing subsystem has access to a power supply line to an electrical equipment;
the data processing subsystem is configured to meter usage data of the electrical equipment through the access to the power supply line to the electrical equipment, and save the usage data in the usage database; and
the data processing subsystem reports the usage data and the identity of system to an external billing system in either or both of wired and wireless ways to calculate a usage charge of the electrical equipment.

19. The usage metering system of claim 18, wherein the usage metering system physically resides inside the electrical equipment to meter the electrical equipment.

20. A usage allowance enforcement system, comprising:
an identity of the system;
a usage database; and
a data processing subsystem,
wherein:
the data processing subsystem has access to a power supply line to an electrical equipment;
the data processing subsystem is configured to accept a usage allowance of the electrical equipment where the usage allowance is in the form of a monetary amount, time duration, an energy consumption measure, or any other form of usage credit;
the data processing subsystem is configured to enforce the usage allowance through the access to the power supply line to the at least one electrical equipment by turning on, off, or partially on the electrical equipment; and
the usage allowance is optionally associated with the identity of the system.

21. The usage allowance enforcement system of claim 20, wherein the system resides inside the electrical equipment to enforce the usage allowance on the electrical equipment.
